(19) United States
(12) Patent Application Publication
(10) Pub. No.: US 2026/0064139 A1
(43) Pub. Date: Mar. 5, 2026

(54) REGULATOR

(71) Applicant: Nikki Co., Ltd., Kanagawa-ken (JP)

(72) Inventors: Yukinori Suematsu, Kanagawa - Ken (JP); Shutaro Aizawa, Kanagawa-ken (JP)

(21) Appl. No.: 19/315,477

(22) Filed: Aug. 29, 2025

(30) Foreign Application Priority Data
Sep. 2, 2024 (JP) 2024-151025

(51) Int. Cl. G05D 16/20; F17C 13/04

(52) U.S. Cl. CPC G05D 16/202; F17C 13/04; F17C 2205/0323; F17C 2205/0338; F17C 2221/033

(57) ABSTRACT

A regulator includes a body that has a fluid introduction port and a fluid discharge port, and a pressure regulation valve that partitions a primary pressure chamber on the fluid introduction port side and a secondary pressure chamber on the fluid discharge port side, and is capable of extracting a fluid whose pressure is adjusted to a predetermined pressure from the fluid discharge port. The pressure regulation valve includes a cylindrical valve body that causes the primary pressure chamber and the secondary pressure chamber to communicate with each other, a valve seat on which the valve body is seated when the valve is closed, and a valve body actuator that causes the valve body to reciprocate in the axial direction. The valve body is formed by joining a head portion that is seated on the valve seat and a body portion that reciprocates in the axial direction.

### CROSS REFERENCE TO RELATED APPLICATION

This application claims priority to Japanese Patent Application No. 2024-151025, filed on September 2, 2024, the contents of which is hereby incorporated by reference in its entirety.

### TECHNICAL FIELD

The present disclosure relates to a regulator that reduces and adjusts a fluid pressure.

### BACKGROUND

As a regulator that discharges a high-pressure fluid such as gas fuel while reducing and adjusting the pressure of the fluid to a predetermined pressure, for example, as disclosed in JP 2019-067216 A, there is a regulator using a piston type pressure regulation valve that adjusts the pressure of the fluid to be discharged by using a pressure regulation spring and a piston to balance a load due to the pressure of the fluid acting on the piston and a load due to the pressure regulation spring acting on the piston.

When gas fuel stored in a cylinder at a relatively high pressure (20 MPa) such as CNG is introduced at the high pressure and depressurized, a temperature becomes an extremely low temperature of around -200°C due to a temperature decrease during adiabatic expansion. For this reason, a valve seat and a valve body of the pressure regulation valve need to have a material and a shape that can withstand such low temperature.

### SUMMARY

That is, for example, in a case of reducing and adjusting the pressure of CNG, it is necessary to prepare pressure regulation valves having a specification of performing pressure reduction from a pressure of 20 MPa having a relatively high pressure requirement and a specification of performing pressure reduction from a pressure of 5 MPa already reduced and having a relatively low pressure requirement. For this reason, there is a problem that manufacturing and management become complicated.

Therefore, an object of the present disclosure is to cope with different pressure requirements and facilitate manufacturing and management in a regulator that reduces and adjusts a fluid pressure.

The present disclosure provides a regulator including: a body in which a passage through which a fluid passes is formed to penetrate the body, the body having one end of the passage as a fluid introduction port and the other end of the passage as a fluid discharge port; and a pressure regulation valve provided on the passage and partitioning a primary pressure chamber on a side of the fluid introduction port and a secondary pressure chamber on a side of the fluid discharge port, the regulator enabling a fluid whose pressure is adjusted to a predetermined pressure to be extracted from the fluid discharge port, in which the pressure regulation valve includes a cylindrical valve body which is capable of reciprocating in an axial direction and causes the primary pressure chamber and the secondary pressure chamber to communicate with each other when a valve is opened, a valve seat which is mounted on the body and on which the valve body is seated when the valve is closed, and a valve body actuator which reciprocates the valve body in the axial direction, and the valve body is formed by joining a head portion seated on the valve seat when the valve is closed and a body portion reciprocating in the axial direction by the valve body actuator.

According to the present disclosure, it is possible to provide a regulator that copes with different pressure requirements and facilitates manufacturing and management.

### BRIEF DESCRIPTION OF DRAWINGS

FIG. 1 is a longitudinal cross-sectional view illustrating a regulator according to a first example of the present disclosure;

FIG. 2A is a partial cross-sectional view illustrating a head portion 21a and a body portion 21b forming a valve body 21A of the regulator illustrated in FIG. 1, and FIG. 2B is a partial cross-sectional view illustrating the head portion 21a and the body portion 21b having different shapes;

FIG. 3 is a view illustrating an assembly process (1) of the regulator illustrated in FIG. 1;

FIG. 4 is a view illustrating an assembly process (2) of the regulator illustrated in FIG. 1;

FIG. 5 is a view illustrating an assembly process (3) of the regulator illustrated in FIG. 1;

FIG. 6 is a longitudinal cross-sectional view illustrating a regulator according to a second example of the present disclosure;

FIG. 7 is a view illustrating an assembly process (2) of the regulator illustrated in FIG. 6; and

FIG. 8 is a view illustrating an assembly process (3) of the regulator illustrated in FIG. 6.

### DETAILED DESCRIPTION

Hereinafter, examples of the present disclosure will be described with reference to the drawings.

### First Example

A first example of the present disclosure will be described below.

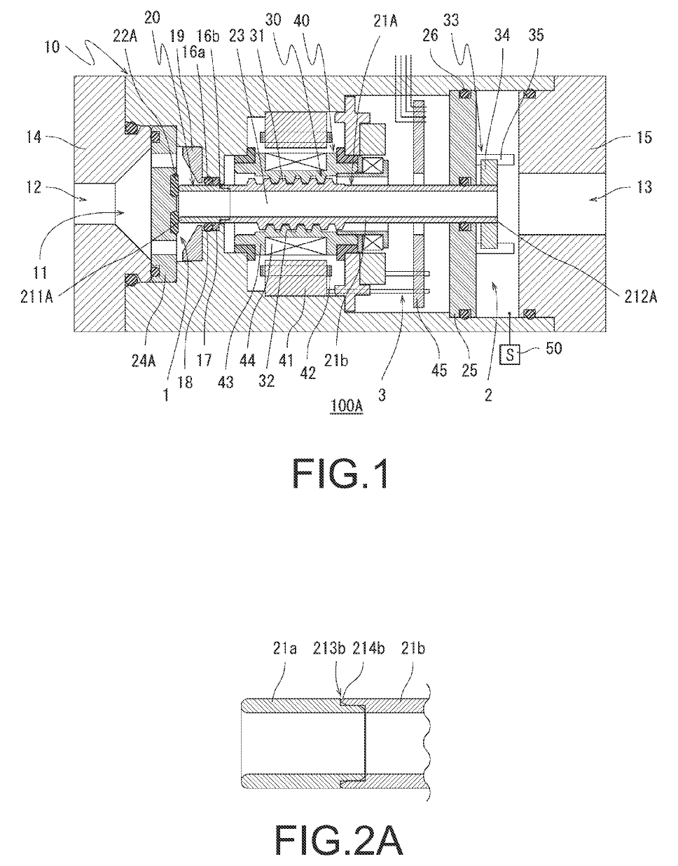

FIG. 1 illustrates a regulator 100A according to the first example of the present disclosure.

The regulator 100A is mainly assumed to be used as a pressure reduction means for delivering gas fuel such as CNG, LPG, or hydrogen gas while reducing a pressure of the gas fuel to a predetermined pressure in a supply system of the gas fuel, and the first example is suitable when a pressure requirement is relatively low.

The regulator 100A is an electronically controlled regulator including a body 10 in which a passage 11 through which a fluid passes is formed to penetrate the body, a pressure regulation valve 20 provided on the passage 11, and an electric motor 40.

The body 10 has a cylindrical shape, and one end of the passage 11 is used as a fluid introduction port 12 and the other end of the passage 11 is used as a fluid discharge port 13.

An inlet cover 14 is attached to the fluid introduction port 12 side, and an outlet cover 15 is attached to the fluid discharge port 13 side.

The pressure regulation valve 20 is provided on the passage 11 to partition a primary pressure chamber 1 on the fluid introduction port 12 side and a secondary pressure chamber 2 on the fluid discharge port 13 side.

A pressure control unit 3 for operating the pressure regulation valve 20 to reduce and adjust the pressure of the fluid to be discharged to a setting pressure is provided between the primary pressure chamber 1 and the secondary pressure chamber 2.

The pressure regulation valve 20 includes a cylindrical valve body 21A capable of reciprocating in an axial direction, a valve seat 22A that contacts and separates from the valve body 21A to open and close the valve, a valve body actuator (in other words, valve body movement means or valve body movement assembly) 30 that reciprocates the valve body 21A in the axial direction, an electric motor 40 that operates the valve body actuator 30, and a pressure sensor 50 that detects the fluid pressure on the secondary pressure chamber 2 side.

When the valve body 21A separates from the valve seat 22A and the valve is opened, the valve body causes the primary pressure chamber 1 on the fluid introduction port 12 side and the secondary pressure chamber 2 on the fluid discharge port 13 side to communicate with each other through a communication hole 23 inside, and moves the fluid from the primary pressure chamber 1 to the secondary pressure chamber 2.

On the other hand, when the valve body 21A is seated on the valve seat 22A and the valve is closed, the movement of the fluid from the primary pressure chamber 1 to the secondary pressure chamber 2 is regulated.

In the valve body 21A, an end portion on a side seated on the valve seat 22A is defined as a distal end 211A, and an end portion on the opposite side is defined as a rear end 212A.

At an intermediate position of the passage 11, a first reduced diameter portion 16a having a reduced inner diameter and a second reduced diameter portion 16b having an inner diameter smaller than that of the first reduced diameter portion 16a and located on the secondary pressure chamber 2 side are continuously formed.

An annular collar 17 and an O-ring 18 located closer to the primary pressure chamber 1 than the collar 17 are attached to the first reduced diameter portion 16a.

The collar 17 has an inner diameter slightly larger than an outer diameter of the valve body 21A, and has a role of guiding the reciprocating operation of the valve body 21A in the axial direction while preventing the valve body 21A from directly contacting the body 10.

A material of the collar 17 can be formed of, for example, a synthetic resin, and particularly, a material having good slipperiness such as PTFE is preferable.

The O-ring 18 has a role of airtightly sealing the first reduced diameter portion 16a and the valve body 21A.

The collar 17 and the O-ring 18 are held so as not to fall off from the first reduced diameter portion 16a by the second reduced diameter portion 16b and a pressing member 19 mounted on the primary pressure chamber 1 side.

The valve seat 22A is formed in an annular shape, and is fixed to a valve seat holding member 24A by a means such as adhesion or insert molding. The valve seat holding member 24A is fitted between the inlet cover 14 and the body 10.

As a material of the valve seat 22A, for example, an elastic material such as rubber can be used, and in particular, hydrogenated nitrile rubber (HNBR) is suitable.

A piston 25 that receives the fluid pressure in the secondary pressure chamber 2 is fixed in the vicinity of the rear end 212A of the valve body 21A.

By providing the piston 25, when the electric motor 40 is stopped, the piston 25 is pushed by the fluid pressure in the secondary pressure chamber 2, and the valve body 21A is pressed against the valve seat 22A, so that the valve can be closed.

The electric motor 40 includes a stator 41 that supports a winding 42 in a wound state, and a rotor 43 in which a magnet 44 is disposed, and is controlled by a driver 45. As the electric motor, for example, an AC servomotor or a DC brushless motor can be used.

The valve body actuator 30 includes a trapezoidal male screw 31 formed on an outer peripheral surface of the valve body 21A, a trapezoidal female screw 32 formed on an inner peripheral surface of the rotor 43 and meshed with the trapezoidal male screw 31, and a rotation stop 33 provided on the rear end side of the valve body 21A, and is a feed screw mechanism that converts a rotational motion of the electric motor 40 into a linear motion.

The rotation stop 33 includes a rotation stop protrusion 34 protruding outward in a circumferential direction at the rear end 212A of the valve body 21A, and a rotation stop guide 35 protruding from the piston 25 in the axial direction (direction toward the fluid discharge port 13) so as to sandwich the rotation stop protrusion 34.

When the electric motor 40 is driven, the rotational motion of the rotor 43 is transmitted to the valve body 21A via the trapezoidal female screw 32 and the trapezoidal male screw 31, but the rotational motion of the valve body 21A is regulated by the contact between the rotation stop protrusion 34 on the valve body 21A side and the rotation stop guide 35 on the piston 25 side, and is converted into the linear motion in the axial direction.

At this time, the strained force of a sealing member 26 attached to the outer periphery of the piston 25 is larger than the motor torque, and in a case of a pressure applied state, a load in a direction of pressing the valve body 21A against the valve seat 22A is also applied, so that the piston 25 and the valve body 21A do not rotate at the same time.

The pressure sensor 50 detects the fluid pressure on the secondary pressure chamber 2 side. Note that the installation position of the pressure sensor is not limited to this location, and for example, a numerical value of the fluid pressure input to an ECU of a vehicle may be used by installing the pressure sensor at another location.

A pressure regulation structure in the present example controls the electric motor 40 based on the fluid pressure on the secondary pressure chamber 2 side detected by the pressure sensor 50 to operate the valve body actuator 30 to thereby operate the pressure regulation valve 20.

By changing a lift amount of the valve body 21A and changing a flow rate of the fluid passing through the communication hole 23 from the primary pressure chamber 1 to the secondary pressure chamber 2, the pressure of the discharged fluid is automatically adjusted to be equal to the setting pressure.

In the present disclosure, the valve body 21A is formed by joining two components of a head portion 21a and a body portion 21b.

The head portion 21a is located on the distal end 211A side of the valve body 21A and has a role of being seated on the valve seat 22A when the valve is closed.

The body portion 21b is located on the rear end 212A side of the valve body 21A and has a role of reciprocating in the axial direction by the valve body actuator 30, and the trapezoidal male screw 31 is formed on the outer peripheral surface of the body portion 21b.

The head portion 21a and the body portion 21b have a shape that can be inlay-fitted (in other words, stepped fitted or spigot fitted), and temporary fixing is performed by press-fitting the head portion 21a having a convex shape into the distal end of the body portion 21b having a concave shape, and then they are integrally joined by laser welding to form the valve body 21A.

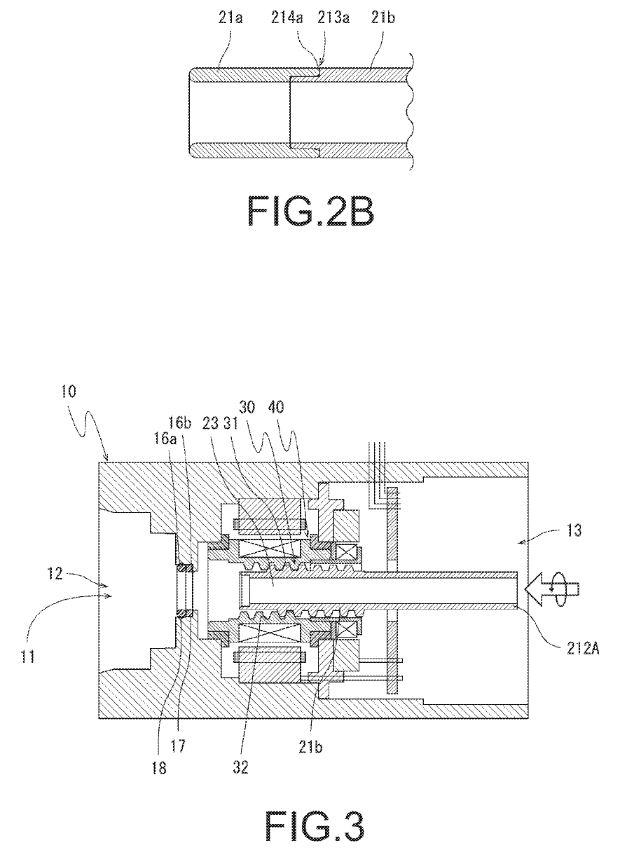

FIG. 2A is a partial cross-sectional view of the head portion 21a and the body portion 21b forming the valve body 21A, and FIG. 2B is a partial cross-sectional view of the head portion 21a and the body portion 21b having different shapes.

As illustrated in FIG. 2B, the head portion 21a having a concave shape may be press-fitted to the distal end of the body portion 21b having a convex shape by reversing unevenness of inlay-fitting.

At least one of the head portion 21a and the body portion 21b is formed with a tapered portion at an outer peripheral end, and the head portion 21a and the body portion 21b are joined with the tapered portion as a welding location.

In the form illustrated in FIG. 2A, a tapered portion 214b is formed at an outer peripheral end 213b of the body portion 21b, and in the form illustrated in FIG. 2B, a tapered portion 214a is formed at an outer peripheral end 213a of the head portion 21a.

The joining method of the head portion 21a and the body portion 21b is not limited to the laser welding, and conventionally known joining methods such as welding other than the laser welding, press-fitting, fitting, caulking, and adhesion can be used.

In the present example, the head portion 21a has a straight shape having the same diameter as that of the body portion 21b.

In the present example, the valve body 21A and the valve seat 22A have a structure in contact with each other in a plane, and the valve body 21A is pressed against the valve seat 22A formed of a material having elasticity such as rubber, so that the valve seat 22A can exert elasticity and come into close contact with the valve body 21A.

Therefore, when the pressure requirement is relatively low, for example, when gas fuel having a moderate pressure of about 5 MPa is introduced, good sealing performance can be obtained.

FIGS. 3 to 5 are views illustrating respective assembly processes (1) to (3) that are assembly processes of the valve body 21A in the first example illustrated in FIG. 1.

FIG. 3 is a view illustrating the assembly process (1). The body portion 21b forming the valve body 21A is inserted while being rotated from the fluid discharge port 13 side, and advances toward the fluid introduction port 12 while screwing the trapezoidal male screw 31 and the trapezoidal female screw 32.

All the components depicted in FIG. 3 are components common to a second example to be described later, and the present disclosure can realize commonization of components between different specifications and facilitate manufacturing and management.

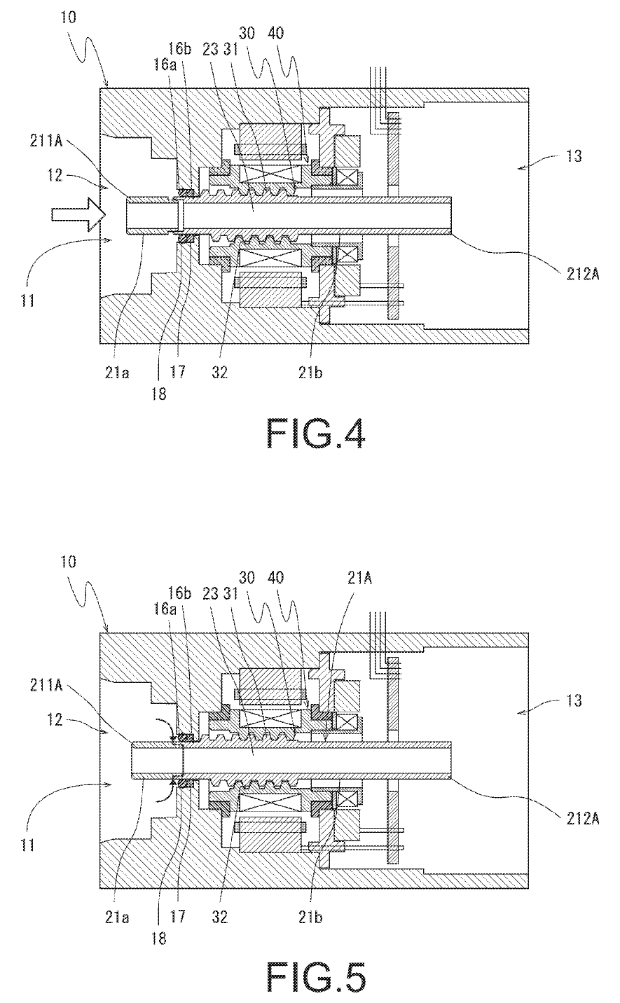

FIG. 4 is a view illustrating the assembly process (2). After the body portion 21b advances toward the fluid introduction port 12 by a predetermined amount and the distal end of the body portion 21b passes through the first reduced diameter portion 16a, the head portion 21a is inserted from the fluid introduction port 12 side and press-fitted into the body portion 21b while being inlay-fitted.

FIG. 5 is a view illustrating the assembly process (3). After the press-fitting of the head portion 21a into the body portion 21b is completed, matching surfaces (black arrow portions) are welded by laser welding to be inseparably joined.

As illustrated in FIG. 2A, in the present example, the tapered portion 214b is formed at the outer peripheral end 213b of the body portion 21b, and the head portion 21a and the body portion 21b are joined with the tapered portion 214b as a welding location.

As a result, protrusion of the welding location between the head portion 21a and the body portion 21b is suppressed without particularly performing post-processing or the like, and the welding location has a shape that is less likely to come into contact with the collar 17 and the O-ring 18, so that adverse effects on slidability and sealability can be avoided.

### Second Example

A second example of the present disclosure will be described below.

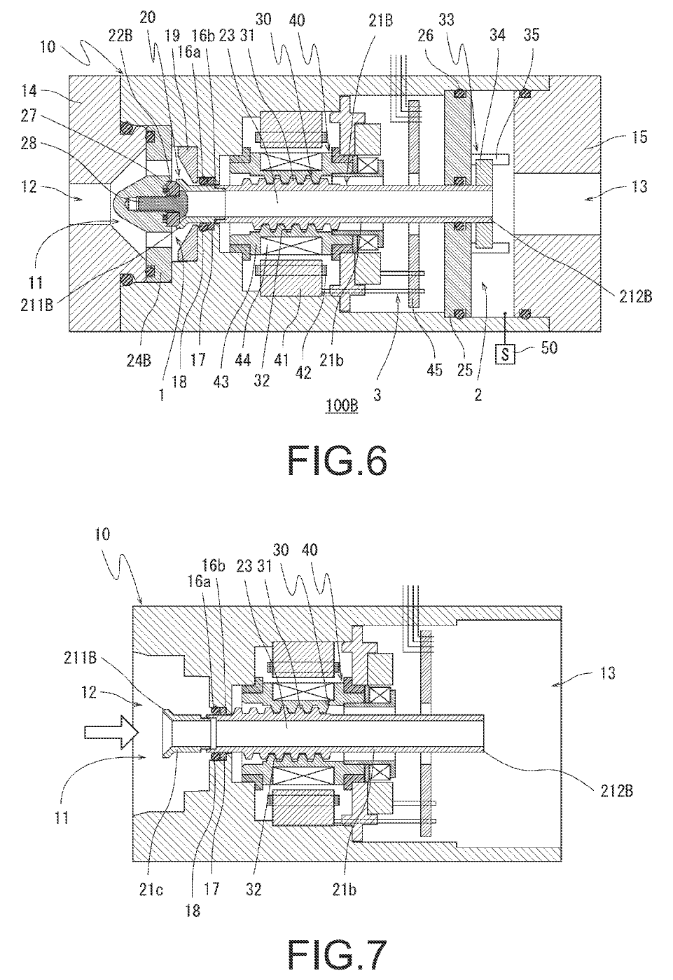

FIG. 6 illustrates a regulator 100B according to the second example of the present disclosure. Since the regulator 100B has a configuration similar to that of the regulator 100A except for structures of a valve body 21B and a valve seat 22B, similar components are denoted by the same reference numerals, and the description thereof will be omitted.

The regulator 100B is mainly assumed to be used as a pressure reduction means for delivering gas fuel such as CNG, LPG, or hydrogen gas while reducing a pressure of the gas fuel to a predetermined pressure in a supply system of the gas fuel, and the second example is suitable when a pressure requirement is relatively high.

The valve body 21B is formed by joining two components of a head portion 21c and a body portion 21b.

The head portion 21c is located on the distal end 211B side of the valve body 21B and has a role of being seated on the valve seat 22B when a valve is closed. The shape thereof is a funnel shape having a cylindrical portion and an expanded portion, and the distal end 211B has an inversely tapered shape having a larger diameter than the body portion 21b.

The body portion 21b is located on the rear end 212B side of the valve body 21B and has a role of reciprocating in an axial direction by a valve body actuator 30, and a trapezoidal male screw 31 is formed on an outer peripheral surface of the body portion 21b.

The valve seat 22B is formed in an annular shape having a rounded outer peripheral edge, and is fixed to a valve seat holding member 24B by a fixing screw 28 inserted into a center hole 27. The valve seat holding member 24B is fitted between an inlet cover 14 and a body 10.

As a material of the valve seat 22B, for example, a material having cold resistance and appropriate flexibility such as a synthetic resin can be used, and polyimide (PI) is particularly suitable.

In the present example, the valve body 21B and the valve seat 22B have a structure in which an inner peripheral surface of the valve body 21B and an outer peripheral edge of the valve seat 22B are in contact with each other in a curved surface, and the valve body 21B is strongly pressed against the valve seat 22B formed of a material such as a synthetic resin, so that the valve seat 22B can come into close contact with the valve body 21B.

Therefore, when the pressure requirement is relatively high, for example, when gas fuel having a high pressure of about 20 MPa is introduced, the valve body 21B is strongly pressed against the valve seat 22B, so that good sealing performance can be obtained.

In addition, although the pressure regulation valve 20 is exposed to an extremely low temperature of around -200°C due to a temperature decrease by adiabatic expansion when the pressure is reduced to around the atmospheric pressure, by using a material such as a synthetic resin, cold resistance higher than that of rubber is exhibited, and the pressure regulation valve can function as a valve even in an environment of an extremely low temperature.

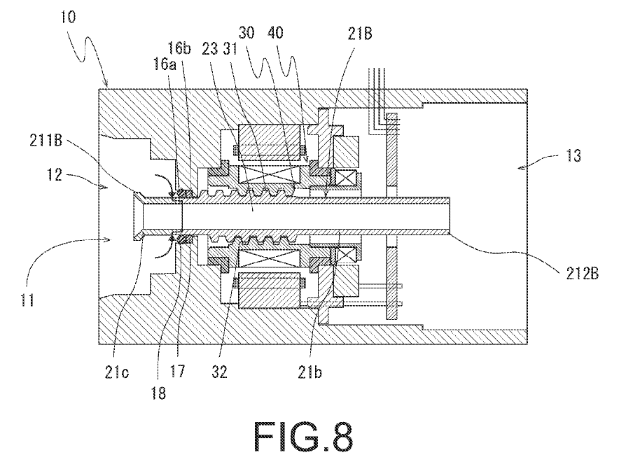

FIGS. 7 and 8 are views illustrating assembly processes (2) and (3) which are assembly processes of the valve body 21B in the second example illustrated in FIG. 6. The assembly process (1) of the valve body 21B is the same as the assembly process (1) of the valve body 21A illustrated in FIG. 3.

As illustrated in FIG. 3, the body portion 21b forming the valve body 21B is inserted while being rotated from the fluid discharge port 13 side, and advances toward the fluid introduction port 12 while screwing the trapezoidal male screw 31 and the trapezoidal female screw 32.

As illustrated in FIG. 7, the body portion 21b forming the valve body 21B advances toward the fluid introduction port 12 by a predetermined amount, the distal end of the body portion 21b passes through the first reduced diameter portion 16a, and then the head portion 21c is inserted from the fluid introduction port 12 side and press-fitted into the body portion 21b while being inlay-fitted.

FIG. 8 is a view illustrating the assembly process (3) of the valve body 21B. After the press-fitting of the head portion 21c into the body portion 21b is completed, matching surfaces (black arrow portions) are welded by laser welding to be inseparably joined.

A diameter of the distal end of the head portion 21c having an inversely tapered shape is larger than diameters of a first reduced diameter portion 16a and a second reduced diameter portion 16b of the body 10, and when the valve body is formed of one component, assembling is impossible.

On the other hand, the valve body 21B is formed of two components of the head portion 21c and the body portion 21b in this manner, and the valve body 21B can be assembled in the body 10 and completed by being inserted and engaged from the fluid discharge port 13 side and the fluid introduction port 12 side, respectively.

As described above, according to the present disclosure, in the regulator that reduces and adjusts the fluid pressure, it is possible to realize commonization of components between different specifications and to facilitate manufacturing and management.

Regarding the valve body in which processing has been difficult because the valve body has a cylindrical shape with a relatively long overall length and includes a screw portion and a valve portion, it is also possible to manufacture each component by different manufacturing means suitable for each, for example, manufacturing the head portion by cutting processing and the body portion by rolling processing, which is advantageous in terms of manufacturing.

Note that the first example and the second example of the present disclosure are electronically controlled regulators having an electric motor, but can be similarly implemented in a piston type regulator having a pressure regulation spring and a piston.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader’s understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

What is claimed is:

1. A regulator comprising:
a body defining a passage therethrough for flow of a fluid, the passage extending between a fluid introduction port and a fluid discharge port; and
a pressure regulation valve disposed in the passage and dividing the passage into a plurality of chambers, the plurality of chambers including a primary pressure chamber adjacent to the fluid introduction port and a secondary pressure chamber adjacent to the fluid discharge port, the pressure regulation valve being operable to allow extraction of fluid at a predetermined pressure from the fluid discharge port,
wherein the pressure regulation valve comprises:
a cylindrical valve body reciprocable along an axial direction and configured to provide communication between the primary pressure chamber and the secondary pressure chamber when in an open position;
a valve seat which is mounted on the body, the valve body being seatable against the valve seat when in a closed position;
a valve body actuator configured to reciprocate the valve body in the axial direction; and
the valve body including a head portion configured to seat against the valve seat when in the closed position, and a body portion reciprocable in the axial direction by the valve body actuator, the head portion and the body portion being joined together.

2. The regulator according to claim 1, wherein the head portion has a straight shape in which a whole portion has the same diameter as the body portion.

3. The regulator according to claim 1, wherein the head portion has an inversely tapered shape having a distal end with a diameter greater than the body portion.

4. The regulator according to claim 1, wherein:
the head portion and the body portion are shaped to allow inlay-fitting; and
the head portion and the body portion are joined together by welding after being inlay-fitted.

5. The regulator according to claim 4, wherein:
at least one of the head portion and the body portion includes a tapered portion at an outer peripheral end; and
the welded join between the head portion and the body portion is at the tapered portion.

6. The regulator according to claim 1, wherein the pressure regulation valve further comprises:
an electric motor configured to operate the valve body actuator; and a pressure sensor configured to detect a fluid pressure of the secondary pressure chamber,
wherein the valve body actuator is controlled by the electric motor in response to the detected fluid pressure of the secondary pressure chamber.

7. The regulator according to claim 6, wherein the valve body actuator comprises:
a trapezoidal male screw on an outer peripheral surface of the body portion of the valve body;
a trapezoidal female screw in a rotor of the electric motor; and
a rotation stop that prevents rotation of the valve body; and
the valve body actuator having a feed screw structure which converts a rotational motion of the electric motor into a linear motion.
